(19) United States
(12) Patent Application Publication
(10) Pub. No.: US 2007/0046614 A1
(43) Pub. Date: Mar. 1, 2007

(54) APPARATUS FOR DRIVING A THIN-FILM TRANSISTOR LIQUID CRYSTAL DISPLAY

(76) Inventor: Chih-Jung Chien, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,498

(22) Filed: Sep. 13, 2005

(30) Foreign Application Priority Data
Aug. 31, 2005 (TW) 94129922

(51) Int. Cl. G09G 3/36

(52) U.S. Cl. 345/100

(57) ABSTRACT

An apparatus for driving a thin-film transistor liquid crystal display is provided. The apparatus is able to reduce power consumption of its source driver IC in the vertical blanking time without affecting image quality in the normal display time. The apparatus comprises an application-specific integrated circuit (ASIC) and a source driver IC. The ASIC outputs a latch pulse signal. The source driver IC has a plurality of output terminals and outputs a data voltage at each of the output terminals in response to the latch pulse signal. The source driver IC further comprises a switch. The switch is electrically connected to two adjacent output terminals of the source driver IC and connects the adjacent output terminals in the vertical blanking time in response to the latch pulse signal.

### CROSS-REFERENCE TO RELATED APPLICATION

This application claims the priority benefit of Taiwan application serial no. 94129922, filed on Aug. 31, 2005. All disclosure of the Taiwan application is incorporated herein by reference.

### BACKGROUND OF THE INVENTION

1. Field of the Invention

The present invention relates to an apparatus for driving a thin-film transistor liquid crystal display. More particularly, the present invention relates to an apparatus for driving a thin-film transistor liquid crystal display, which is able to reduce its power consumption.

2. Description of the Related Art

As shown in FIG. 1, for sharing control signals between modern thin-film transistor liquid crystal displays (TFT LCD) and traditional cathode-ray tube (CRT) monitors, a frame field of a TFT LCD not only includes the normal display time 101, in which images are displayed normally, but also includes the horizontal blanking time 102 and the vertical blanking time 103, in which the TFT LCD does not display images. In FIG. 1, DE stands for the data enable signal. And SOP stands for the output signal of a source driver integrated circuit (IC).

As can be seen in FIG. 1, although no images are displayed in the vertical blanking time 103, traditional source driver IC still outputs the output signal SOP that alternates its polarity constantly in the vertical blanking time 103. In other words, the source driver IC still consumes electrical current in the vertical blanking time 103, adding to the power consumption of the LCD module.

### SUMMARY OF THE INVENTION

Accordingly, the present invention is directed to an apparatus for driving a thin-film transistor liquid crystal display. The apparatus is able to avoid power consumption of dynamic current in the source driver IC and only consumes a little of steady current in the vertical blanking time in which no images are displayed. As a result, the apparatus is able to reduce power consumption of the entire module without affecting image quality in the normal display time.

According to an embodiment of the present invention, an apparatus for driving a thin-film transistor liquid crystal display is provided. The apparatus comprises an application-specific integrated circuit (ASIC) and a source driver IC. The ASIC is for outputting a latch pulse signal. The source driver IC has a plurality of output terminals and outputs a data voltage at each of the output terminals in response to the latch pulse signal.

In an embodiment of the present invention, the source driver IC further comprises a switch. The switch is electrically connected to two adjacent output terminals and connects the adjacent output terminals in a vertical blanking time in response to the latch pulse signal.

In an embodiment of the present invention, the switch connects the adjacent output terminals when the latch pulse signal is logically high and disconnects the adjacent output terminals when the latch pulse signal is logically low, and the latch pulse signal is logically high in the vertical blanking time.

In an embodiment of the present invention, the switch comprises a transistor.

According to another embodiment of the present invention, an apparatus for driving a thin-film transistor liquid crystal display is provided. The apparatus comprises an ASIC and a source driver IC. The ASIC outputs a latch pulse signal. The source driver IC has a plurality of output terminals and outputs a data voltage at each of the output terminals in response to the latch pulse signal. Furthermore, the source driver IC comprises a plurality of digital-to-analog converters, a plurality of buffers, a plurality of resistors and a switch. The digital-to-analog converters have a one-to-one correspondence with the output terminals. Each of the digital-to-analog converters converts a pixel data to the corresponding data voltage according to a gamma voltage and outputs the corresponding data voltage. The buffers also have a one-to-one correspondence with the output terminals. Each of the buffers is electrically connected to the corresponding digital-to-analog converter and buffers the corresponding data voltage before the corresponding data voltage is outputted at the corresponding output terminal. The resistors also have a one-to-one correspondence with the output terminals. Each of the resistors is electrically connected between the corresponding buffer and the corresponding output terminal. Finally, the switch, has a first terminal electrically connected between a first buffer and a first resistor corresponding to a first output terminal of the source driver IC and a second terminal electrically connected between a second buffer and a second resistor corresponding to a second output terminal adjacent to the first output terminal of the source driver IC. The switch connects the first output terminal and the second output terminal in a vertical blanking time in response to the latch pulse signal.

The apparatus of the present invention maintains the latch pulse signal at a logical high voltage to turn on the switch in order to connect two adjacent output terminals in the vertical blanking time. The charge sharing mechanism of the source driver IC will be triggered and the source IC will output direct current (DC) voltages close to the common voltage. Therefore, the apparatus is able to avoid power consumption of dynamic current in the source driver IC and only consumes a little of steady current in the vertical blanking time in which no images are displayed. As a result, the apparatus is able to reduce power consumption of the entire module without affecting image quality in the normal display time.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a traditional frame field and its horizontal blanking time and vertical blanking time.

FIG. 2 is a schematic diagram showing an apparatus for driving a TFT LCD according to an embodiment of the present invention.

FIG. 3 is a schematic diagram showing a part of the circuitry of the source driver IC of the apparatus for driving a TFT LCD according to an embodiment of the present invention.

FIG. 4 is a schematic diagram showing the timing of signals related to the apparatus for driving a TFT LCD according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Please refer to FIG. 2, which shows an apparatus for driving a TFT LCD according to an embodiment of the present invention. The apparatus comprises the ASIC 201, the source driver IC 204 and the gate driver IC 203.

In this embodiment, the ASIC 201 is a customized IC which outputs the pixel data Data and the control signal CS to the source driver IC 204. The control signal CS comprises a plurality of signals, including the start pulse signal and the latch pulse signal. The components of the control signal CS will be discussed in details below.

The source driver IC 204 has a plurality of output terminals. The source driver IC 204 converts the pixel data Data from digital signals to analog data voltages in response to the latch pulse signal and outputs the data voltages through the output terminals to each pixel of the TFT LCD panel 202. The gate driver IC 203 is in charge of loading the data voltages derived from the pixel data Data into each pixel of each horizontal scan line of the TFT LCD panel 202. This embodiment focuses on the apparatus comprising the ASIC 201 and the source driver IC 204.

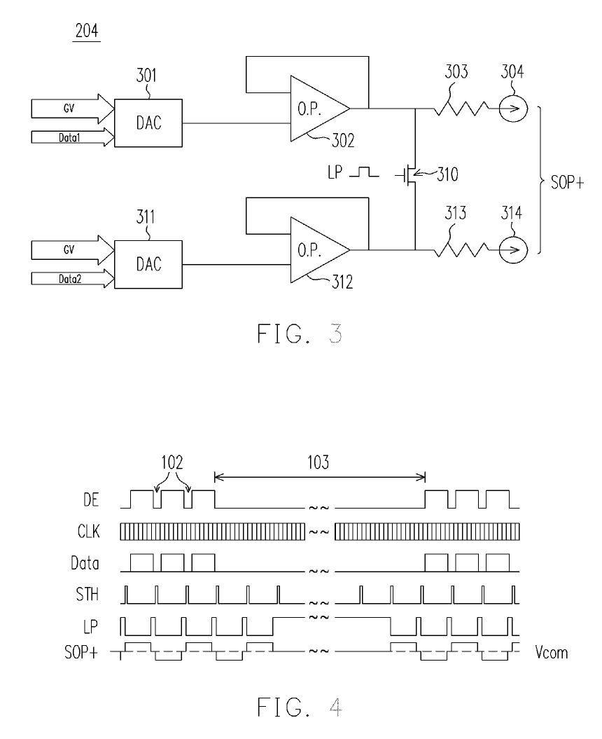

FIG. 3 is a schematic diagram showing a part of the source driver IC 204 in this embodiment. FIG. 3 shows only a part of the source driver IC 204 which comprises the two output terminals 304 and 314. Actually, the source driver IC 204 in this embodiment may comprise an arbitrary number of output terminals, wherein each of the output terminals outputs a data voltage derived from the pixel data.

Each output terminal of the source driver IC 204 has a corresponding digital-to-analog converter (DAC), a corresponding buffer and a corresponding resistor. For example, the output terminal 304 corresponds to the DAC 301, the buffer 302 and the resistor 303. The DAC 301 converts the pixel data Data1 to the data voltage corresponding to the output terminal 304 according to the gamma voltage GV and outputs the data voltage, wherein the gamma voltage GV is a series of voltages used in the digital-to-analog conversion. The buffer 302 is electrically connected to the DAC 301. The buffer 302 buffers the corresponding data voltage before the data voltage is outputted at the output terminal 304. Here the “buffering” of the data voltage means maintaining the voltage level and enhancing the driving capability of the data voltage. In this embodiment, each of the buffers 302 and 312 comprises an operational amplifier. The resistor 303 is electrically connected between the buffer 302 and the output terminal 304. The partial circuit corresponding to the output terminal 314 works in the same way as that of the partial circuit corresponding to the output terminal 304. However, the partial circuit corresponding to the output terminal 314 receives the pixel data Data2 instead of Data1.

In addition to the partial circuits corresponding to the output terminals 304 and 314, the source driver IC 204 in FIG. 3 also comprises the switch 310. In this embodiment, the switch 310 comprises a transistor having a first terminal electrically connected between the buffer 302 and the resistor 303 corresponding to the output terminal 304, and a second terminal electrically connected between the buffer 312 and the resistor 313 corresponding to the output terminal 314. The switch 310 connects the adjacent output terminals 304 and 314 in response to the latch pulse signal LP in the vertical blanking time to activate the charge sharing mechanism already existing in current source driver integrated circuits so that the output terminals 304 and 314 will output the average of their respective data voltages before the vertical blanking time. As a result, the output terminals 304 and 314 will output a DC voltage close to the common voltage in the vertical blanking time instead of the signals with alternating polarity before the vertical blanking time. The connecting of the output terminals 304 and 314 neither drains current from the buffers 302 and 312 nor sinks current into the buffers 302 and 312. Therefore, the power consumption caused by the current of the buffers 302 and 312 when the output terminals 304 and 314 change polarity can be reduced to almost zero.

In this embodiment, the switch 310 connects the output terminals 304 and 314 when the latch pulse signal LP is logically high and disconnects the output terminals 304 and 314 when the latch pulse signal LP is logically low. The latch pulse signal LP is logically high in the vertical blanking time. The above behaviors can be inverted when necessary. In such a case, the switch 310 would connect the output terminals 304 and 314 when the latch pulse signal LP is logically low and disconnect the output terminals 304 and 314 when the latch pulse signal LP is logically high. And the latch pulse signal LP would be logically low in the vertical blanking time.

FIG. 3 shows only a switch 310. In fact, for reducing the power consumption to a minimum, the source driver IC 204 may comprise a plurality of switches. Each of the switches is electrically connected between two adjacent output terminals. In this way, all output terminals of the source driver IC 204 will output DC voltages close to the common voltage in the vertical blanking time.

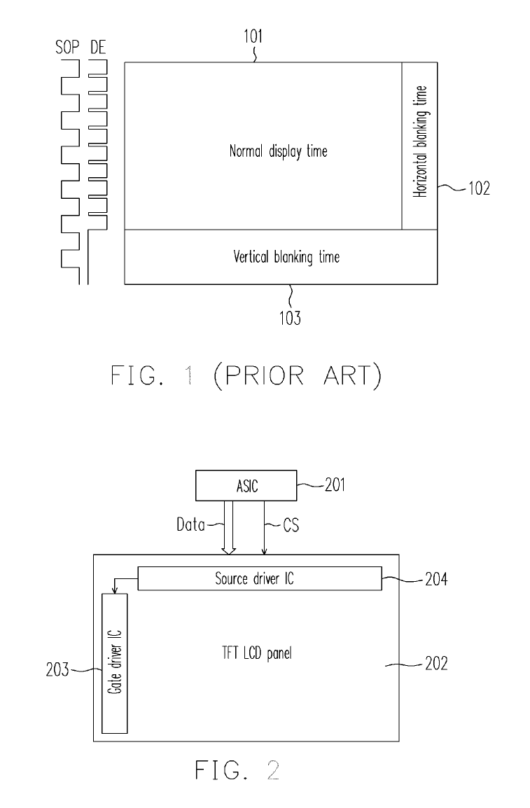

Finally, FIG. 4 is a schematic diagram showing the timing of signals related to this embodiment. As shown in FIG. 4, the pixel data Data is valid when the data enable signal DE is logically high. The first two short intervals in which the data enable signal DE is logically low correspond to the horizontal blanking time 102 in FIG. 1, while the next long interval in which the data enable signal DE is logically low correspond to the vertical blanking time 103 in FIG. 1. CLK is the clock signal of the entire apparatus for driving the TFT LCD in this embodiment. The start pulse signal STH marks the beginning time of every batch of the pixel data Data. LP is the latch pulse signal mentioned above. As shown in FIG. 4, the latch pulse signal LP is logically high in most of the vertical blanking time 103. As a result, the data voltages SOP+outputted by the source driver IC 204 become DC voltages close to the common voltage Vcom instead of the signals with alternating polarity outside the vertical blanking time 103.

As can be seen in the discussions above, the apparatus of the present invention maintains the latch pulse signal at a logical high voltage to turn on the switch in order to connect two adjacent output terminals in the vertical blanking time. The existing charge sharing mechanism of the source driver IC will be triggered and the source IC will output direct current (DC) voltages close to the common voltage. Therefore, the apparatus is able to avoid power consumption of dynamic current in the source driver IC and only consumes a little of steady current in the vertical blanking time in which no images are displayed. As a result, the apparatus is able to reduce power consumption of the entire module without affecting image quality in the normal display time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for driving a thin-film transistor liquid crystal display, comprising:
an application-specific integrated circuit (ASIC) for outputting a latch pulse signal; and
a source driver integrated circuit (IC), having a plurality of output terminals, outputting a data voltage at each of the output terminals in response to the latch pulse signal;
wherein the source driver IC further comprises:
a switch, electrically connecting two adjacent output terminals, connecting the adjacent output terminals in a vertical blanking time in response to the latch pulse signal.

2. The apparatus of claim 1, further comprising connecting the output terminals adjacent to the switch when the latch pulse signal is logically high and disconnecting the output terminals adjacent to the switch when the latch pulse signal is logically low, wherein the latch pulse signal is logically high in the vertical blanking time.

3. The apparatus of claim 1, further comprising connecting the output terminals adjacent to the switch when the latch pulse signal is logically low and disconnecting the output terminals adjacent to the switch when the latch pulse signal is logically high, wherein the latch pulse signal is logically low in the vertical blanking time.

4. The apparatus of claim 1, wherein the switch comprises a transistor.

5. The apparatus of claim 1, wherein the source driver IC further comprises:
a plurality of digital-to-analog converters, each of the digital-to-analog converters electrically connected to the corresponding output terminal, converting a pixel data to the data voltage according to a gamma voltage, and outputting the data voltage.

6. The apparatus of claim 1, wherein the source driver IC further comprises:
a plurality of buffers, each of the buffers electrically connected to the corresponding output terminal, buffering the corresponding data voltage before outputting the corresponding data voltage at the corresponding output terminal.

7. The apparatus of claim 6, wherein each of the buffers comprises an operational amplifier.

8. The apparatus of claim 1, wherein the source driver IC further comprises:
a plurality of resistors, each of the resistors electrically connected to the corresponding output terminal.

9. An apparatus for driving a thin-film transistor liquid crystal display, comprising:
an ASIC for outputting a latch pulse signal; and
a source driver IC, having a plurality of output terminals, outputting a data voltage at each of the output terminals in response to the latch pulse signal;
wherein the source driver IC further comprises:
a plurality of digital-to-analog converters, each of the digital-to-analog converters converting a pixel data to the corresponding data voltage according to a gamma voltage, and outputting the corresponding data voltage;
a plurality of buffers, each of the buffers electrically connected to the corresponding digital-to-analog converter, buffering the corresponding data voltage before outputting the corresponding data voltage at the corresponding output terminal;
a plurality of resistors, each of the resistors electrically connected between the corresponding buffer and the corresponding output terminal; and
a switch, having a first terminal and a second terminal and connecting a first output terminal with a second output terminal adjacent to the first output terminal, the first terminal electrically connected between the buffer and the resistor corresponding to the first output terminal, and the second terminal electrically connected between the buffer and the resistor corresponding to the second output terminal, the switch connecting the first output terminal and the second output terminal in a vertical blanking time in response to the latch pulse signal.

10. The apparatus of claim 9, further comprising connecting the first output terminal and the second output terminal adjacent to the switch when the latch pulse signal is logically high and disconnecting the first output terminal and the second output terminal adjacent to the switch when the latch pulse signal is logically low, wherein the latch pulse signal is logically high in the vertical blanking time.

11. The apparatus of claim 9, further comprising connecting the first output terminal and the second output terminal adjacent to the switch when the latch pulse signal is logically low and disconnecting the first output terminal and the second output terminal adjacent to the switch when the latch pulse signal is logically high, wherein the latch pulse signal is logically low in the vertical blanking time.

12. The apparatus of claim 9, wherein the switch comprises a transistor.

13. The apparatus of claim 9, wherein each of the buffers comprises an operational amplifier.
